(19) United States
(12) Patent Application Publication
(10) Pub. No.: US 2016/0344170 A1
(43) Pub. Date: Nov. 24, 2016

(54) Remote Control Tool Assembly For Use In Live Line Environments

(71) Applicant: Carl Russel Tamm, Trussville, AL (US)

(72) Inventor: Carl Russel Tamm, Trussville, AL (US)

(21) Appl. No.: 15/205,343

(22) Filed: Jul. 8, 2016

Related U.S. Application Data
(63) Continuation-in-part of application No. 13/650,215, filed on Oct. 12, 2012, now abandoned.

(51) Int. Cl. H02G 1/00; H02G 1/02; B25F 5/02

(52) U.S. Cl. CPC H02G 1/005; B25F 5/02; H02G 1/02

(57) ABSTRACT

A remote control tool assembly for use in live line environments having an insulated pole (often termed a “hot stick”) with a tool at one end that generally includes a power supply so that the tool is fully isolatable at the end of the insulated pole. At the other end, a tool control transmitter is positioned which is configured to communicate wirelessly with the tool. Thus, the user can operate the tool remotely from the tool controller, which is particularly useful in a live line environment. A tool body assembly and a tool having a tool body assembly is disclosed.

### CROSS REFERENCE TO RELATED APPLICATION

This application is a continuation-in-part of U.S. patent application Ser. No. 13/650,215, filed Oct. 12, 2012, entitled “Remote Control Tool Assembly For Use In Live Line Environments,” the entire specification of which is hereby incorporated by reference in its entirety.

### BACKGROUND OF THE DISCLOSURE

1. Field of the Disclosure

The disclosure relates in general to a remotely operated device, and more particularly, to a remote control tool assembly. The tool assembly is well suited for operations in live line environments, where insulation of a user (i.e., lineman) is well needed. Of course, the assembly is not limited for use in such an environment, and may have utility in other environments.

2. Background Art

The need to maintain high voltage transmission and distribution equipment, apparatuses and lines is well known in the art. It is known that in many applications, the devices must be serviced and/or maintained while energized. In many instances, above certain thresholds (in some instances over 25 kV in other instances over 500 kV), it is common to utilize insulated poles (often termed a “hot stick”) to insulate a lineman from the high voltage. One such insulated pole is shown in U.S. Pat. No. 2,316,204 issued to Williams. It has been known to adapt a hand tool, such as a ratchet, to the end of such an insulated pole, either directly or through a swivel mechanism (often termed a “jack ratchet”). In prior applications, such as is shown in U.S. Pat. No. 4,326,316, issued to Dolenti, hydraulically powered tools have been provided and coupled to the end of an insulated pole.

Problematically, in each such situation, there are limitations. First, with hand tools, there are limitations as to the amount of torque or force that can be applied, and also difficulty with respect to having the strength to articulate the tools through a desired articulation. With respect to the hydraulically powered tools, there have been other problems. First, the tools themselves are quite heavy. In turn, it is difficult for a lineman to properly control the tool at the opposite end of the insulated pole. In addition, such hydraulic powered tools require a remotely positioned hydraulic power source (and thus, hydraulic lines from the power source to the hydraulic powered tool itself). For these reasons, the hydraulically powered tools have not been well received.

It is an object of the present disclosure to provide a power tool that can be utilized at the end of an insulated pole in a live line environment.

It is another object of the present disclosure to provide a power tool that is remotely actuated by a user at one end of an insulated pole with the tool at the other end of the insulated pole in a live line environment.

It is another object of the invention to provide a power tool that includes a power source coupled thereto which is remotely actuated by a user at one end of an insulated pole with the tool at the other end of the insulated pole in a live line environment.

These objects as well as other objects of the present disclosure will become apparent in light of the present specification, claims, and drawings.

### SUMMARY OF THE DISCLOSURE

The disclosure is directed to a tool body assembly for a remote control tool assembly for use in live line environments comprising a case assembly and a frame spine member. The case assembly has a first case half and a second case half that matingly engage about respective outer rims. Each of the first case half and second case half including, a tool work end cavity; a controller cavity; a battery cavity; and an upper opening in communication with the work end cavity. The frame spine member is positioned between the first case half and the second case half so as to be sandwiched therebetween. The frame spine member includes a primary body including a substantially horizontal leg and a substantially vertical leg, with a lower projection extending from the substantially horizontal leg and beyond the case assembly to define an attachment member structurally configured to receive a distal end of an insulating pole. An upper transverse beam extends between the tool work end cavity and the battery cavity.

In some configurations, the first case half and the second case half are substantial mirror images of each other.

In some configurations, the lower projection defines the lowermost portion of the tool body assembly.

In some configurations, the center of mass is positioned at the lower projection. As a result, half of the mass is to one side of the lower projection and half of the mass is to the other side of the lower projection.

In some configurations, a Faraday cage positioned about at least the battery cavity and the controller cavity.

In some configurations, the Faraday cage comprises a conductive paint applied to the inner surface of the first case half and the second case half.

In some configurations, the Faraday cage further comprises a conductive rubber boot extending about the battery cavity.

In some configurations, the upper transverse beam extends from the substantially vertical leg of the primary body and includes a front end and back portion. The back portion includes a flat portion that is substantially collinear with the front portion, and an upwardly curved portion beyond the flat portion.

In some configurations, the upwardly curved portion substantially corresponds to the lower projection, while being spaced apart therefrom by the substantially vertical leg.

In some configurations, the frame spine member and the first and second case halves each include corresponding openings structurally configured to allow for a fastener therethrough, to, in turn, couple the structures together, sandwiching the frame spine member therebetween.

In some configurations, the battery pack cavity further includes a battery pack opening that provides ingress into the battery cavity.

In some configurations, a battery cover is structurally configured to extend about the battery pack opening. The battery cover is coupled to the first case half and the second case half.

In some configurations, the battery cover includes a conductive rubber material to form a Faraday cage therearound.

In another aspect of the disclosure, the disclosure is directed to a tool that comprises the tool body identified herein, and further includes a power source positioned within the battery cavity; a tool working end positioned within the battery cavity with a tool coupling member extending through the upper opening; and control circuitry positioned within the controller cavity, and electrically coupled to each of the poser source and the tool working end.

In some configurations, a Faraday cage is formed around the power source and the control circuitry.

In some configurations, the Faraday cage comprises a conductive paint coating the first and second case half and a conductive rubber boot about the battery.

In some configurations, the lower projection extends from the tool body assembly in a position such that half of the weight of the tool is on one side of the lower projection with half of the weight of the tool on a side opposite the one side of the lower projection so that the tool is balanced about the lower projection.

### BRIEF DESCRIPTION OF THE DRAWINGS

The disclosure will now be described with reference to the drawings wherein:

FIG. 1 of the drawings is a perspective view of the remote control tool assembly of the present disclosure, which is well suited for use in live line environments;

FIG. 2 of the drawings is a side elevational view of the remote control tool assembly of the present disclosure;

FIG. 3 of the drawings is a partial perspective view of the remote control tool assembly of the present disclosure, showing, in particular, the tool along with the tool attachment assembly of the insulated pole and the tool attachment member of the tool;

FIG. 4 of the drawings is a partial perspective view of the remote control tool assembly of the present disclosure, showing, in particular, the tool along with the tool attachment assembly of the insulated pole and the tool attachment member of the tool;

FIG. 5 of the drawings is a partial perspective view of the remote control tool assembly of the present disclosure, showing, in particular, the first end of the body of the insulated pole having the tool control transmitter coupled thereto;

FIG. 6 of the drawings is a partial perspective view of the remote control tool assembly of the present disclosure, showing, in particular, the first end of the body of the insulated pole having the tool control transmitter coupled thereto;

FIG. 7 of the drawings is a partial side elevational view of the remote control tool assembly of the present disclosure, showing, in particular, the first end of the body of the insulated pole having the tool control transmitter coupled thereto;

FIG. 8 of the drawings is a partial side elevational view of the remote control tool assembly of the present disclosure, showing, in particular, the first end of the body of the insulated pole having the tool control transmitter coupled thereto;

FIG. 9 of the drawings is a first side perspective view of the tool assembly of the present disclosure;

FIG. 10 of the drawings is a second side perspective view of the tool assembly of the present disclosure;

FIG. 11 of the drawings is a perspective view of the first case half of the present disclosure;

FIG. 12 of the drawings is a perspective view of the second case half of the present disclosure;

FIG. 13 of the drawings is a first side perspective view of the tool assembly of the present disclosure, showing, in particular, the removal of the first case half;

FIG. 14 of the drawings is a side elevational view of the frame spine member of the present disclosure;

FIG. 15 of the drawings is a perspective view of the frame spine member of the present disclosure; and

FIG. 16 of the drawings is a perspective view of the battery cover of the present disclosure.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

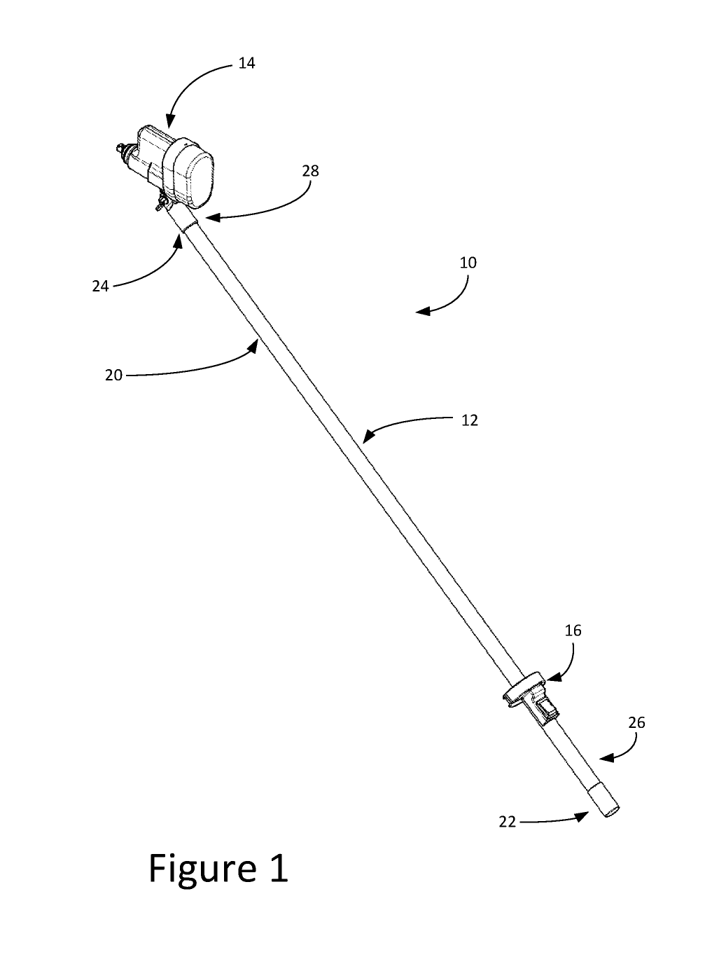

Referring now to the drawings and in particular to FIG. 1, remote control tool assembly for live line environments is shown as 10. It will be understood that such a tool has utility in a live line environment by providing a powered tool at one end that is fully electrically isolated from the other end of the tool, but controllable from the other end of the tool. As will be explained, among other tools, an impact tool, drills, reciprocating saws, grinders, chainsaws, cable cutting tools, compression tools, among others can be utilized at the first end, and controlled from the second end of the tool, in a completely isolated configuration.

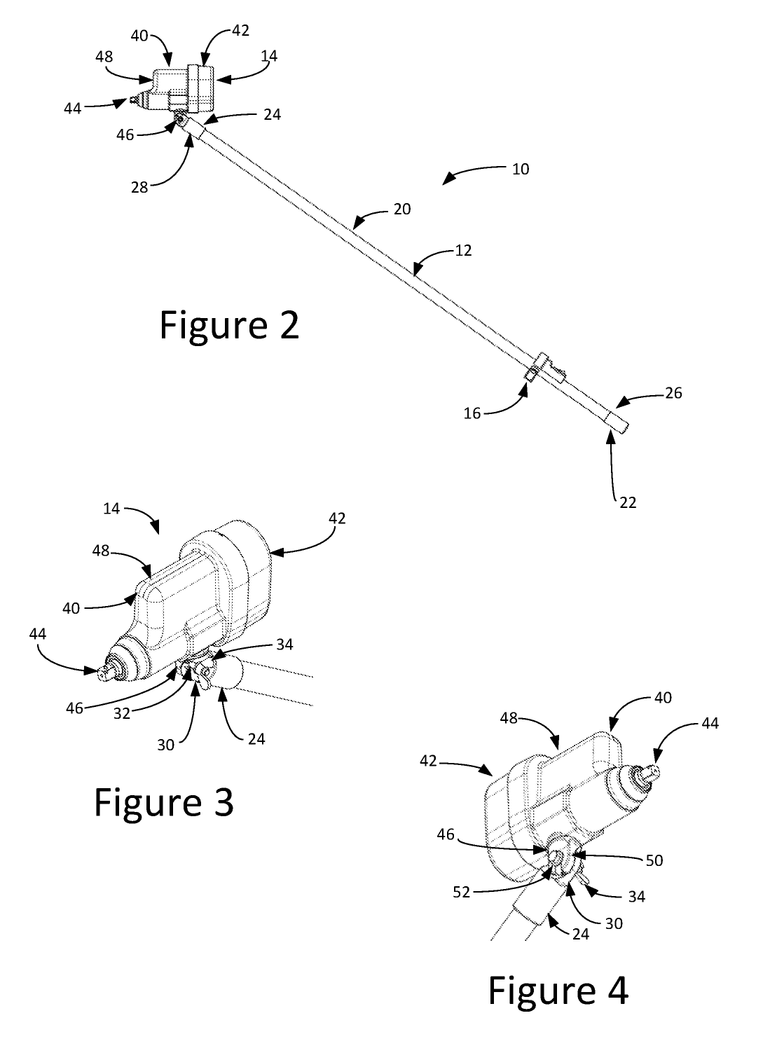

The remote control tool assembly 10 is shown in FIGS. 1 and 2 as comprising insulated pole 12, tool 14 and tool control transmitter 16. The insulated pole 12, commonly referred to as a “hot stick”, includes elongated body 20 having a first end 26 and a second end 28 opposite the first end 26. A handle 22 is provided at the first end 26 of the elongated body 20. A tool attachment assembly 24 is coupled to the second end 28 of the elongated body. The elongated body 20 of the insulated pole 12 comprises an insulative material, such as a fiberglass or the like, and is typically substantially uniform and substantially circular in cross-sectional configuration. Of course, other insulative materials are also contemplated for use, including, but not limited to polymers, organic materials and the like, as are different cross-sectional configurations and variations thereto along the length thereof. Generally, the elongated body may comprise a single monolithic member which is between two and ten feet in length. In other configurations, longer or shorter members are likewise contemplated. For longer members, the elongated body may comprise a plurality of elements that can be coupled together (i.e., end to end, or telescopic). It will be understood that the length of the insulated pole is often dictated by the voltage of the line upon which the user/lineman is operating. For example, up to 15 kV, a minimum phase to ground distance of two feet, one inch must be maintained. Between 161 kV and 169 kV a minimum phase to ground distance of four feet must be maintained. At 500 kV, a minimum phase to ground distance of eleven feet, three inches must be maintained. It is known to one of skill in the art that such distances have been established and are known in the art.

The handle 22 shown at first end 26 may comprise any number of different configurations. In one embodiment, the handle 22 may comprise a rubber or other natural or synthetic resilient member which aids in the retention of the insulated pole by the user. Generally, such a handle 22 will include a grip retaining surface configuration, such that the material and the surface configuration aids in the gripping thereof by a user, even in inclement weather.

With reference to FIGS. 3 and 4, the tool attachment assembly 24 is shown at second end 28 as comprising flange 30 having opening 32 and fastener 34. The flange 30 extends outward from the second end 28, with the opening 32 extending therethrough, substantially perpendicular to the flange 30. As will be explained, the flange 30 corresponds to a mounting assembly flange 50 of the tool 14, with the fastener 34 extending between both of the flanges coupling the two together, wherein a certain amount of pivoting is permitted relative to the flanges. The fastener may include a commonly utilized bolt and nut, or may comprise a quick connect type of connector that allows for easy loosening/tightening and quick adjustment. Of course, other fasteners are likewise contemplated, such as, for example, pins, industrial Velcro, magnetic closures, among others.

Of course, other configurations of the attachment assembly are contemplated. For example, a locking ball and socket can be utilized to permit pivoting and rotation in multiple planes and dimensions, thus, allowing multiple degrees of freedom of relative movement. In other embodiments, the tool and the insulated pole may be coupled to each other in a fixed orientation, wherein the two are not movable relative to each other when coupled together. In still other embodiments, the tool and the insulated pole may be coupled together in a remotely movable configuration.

The tool 14 is shown in FIGS. 3 and 4 as comprising body 40, power source 42, tool work end 44 and attachment member 46. Body 40 generally includes any mechanical portions of the tool (such as, for example, a motor, gears, transmission, control circuitry, among others). Among other items, the control circuitry includes receiver 48 which is configured to receive signals from the tool control transmitter 16. The particular manner in which the receiver communicates with the tool control transmitter will be described below. It will be understood that the receiver 48 is energized by the power source 42 and is electrically coupled to the motor, for example, which is mechanically coupled to the tool work end 44.

Power source 42 comprises a self-contained battery pack (for example, an 18V lithium ion battery pack). Of course, other battery technologies are contemplated, such as alkaline, Ni-CAD, NIMH, LIPolymer, among others). Preferably, the power source 42 is releasably coupled to the tool in a single unit. In such an assembly, multiple power sources can be carried, and replaced if the charge is depleted.

Additionally, other power sources, generally that are self-contained are likewise contemplated for use. These could include solar cells (generally coupled to control circuitry and battery cells), fuel cells, and the like. It is preferred that the power source 42 be coupled to the elongated body at the second end of the insulated pole 12. In other embodiments, it is contemplated that the power source is separated from the tool and coupled thereto through cables and the like. In such an instance, the power source is nevertheless positioned at the second end 28 of the elongated body with a substantial portion of the insulated pole extending between the power source and the first end 26 of the elongated body 20.

The tool working end 44 generally comprises the moving portion of the tool that moves relative to the tool. This may include rotating portions, translating portions, pivoting portions, among others. It is contemplated that any number of different tools may be utilized. With reference to FIG. 1, an impact tool is shown. Such a tool generally has a rotating tip which has a ratchet drive (i.e., typically ½″ drive or ¾″ drive) configured to receive sockets and the like. Of course, other configurations are likewise contemplated, such as smaller ratchet drives, or larger industry specific ratchet drives.

Of course, other tools are likewise contemplated. For example, the tool may comprise a drill with a chuck positioned at the working end which is configured to releasably retain a drill bit or the like. The tool may also comprise another piece of equipment which has a rotating bit, such as a scroll saw, or a cutoff wheel or grinder, a cable cutting tool, among others. In other embodiments, the tool may comprise a vibrating tool, such as a multi-tool or the like, wherein the blade working portion comprises a bit (such as a saw or blade) that vibrates through small oscillations back and forth along a plane that is generally perpendicular to the tool axis. In yet other embodiments, the tool may comprise a saw wherein the blade or saw oscillations are generally along the axis of the tool. In still other embodiments, the tool may comprise a chainsaw. In still other embodiments, the tool may comprise a compression tool. The particular configuration of the tool, and the particular tool contemplated is not limited by the present disclosure, and, generally such tools (but not the manner described in this disclosure) are known for use at or near live line environments, that is, either on the lines directly, or on other objects proximate a line (i.e., tree branches and the like).

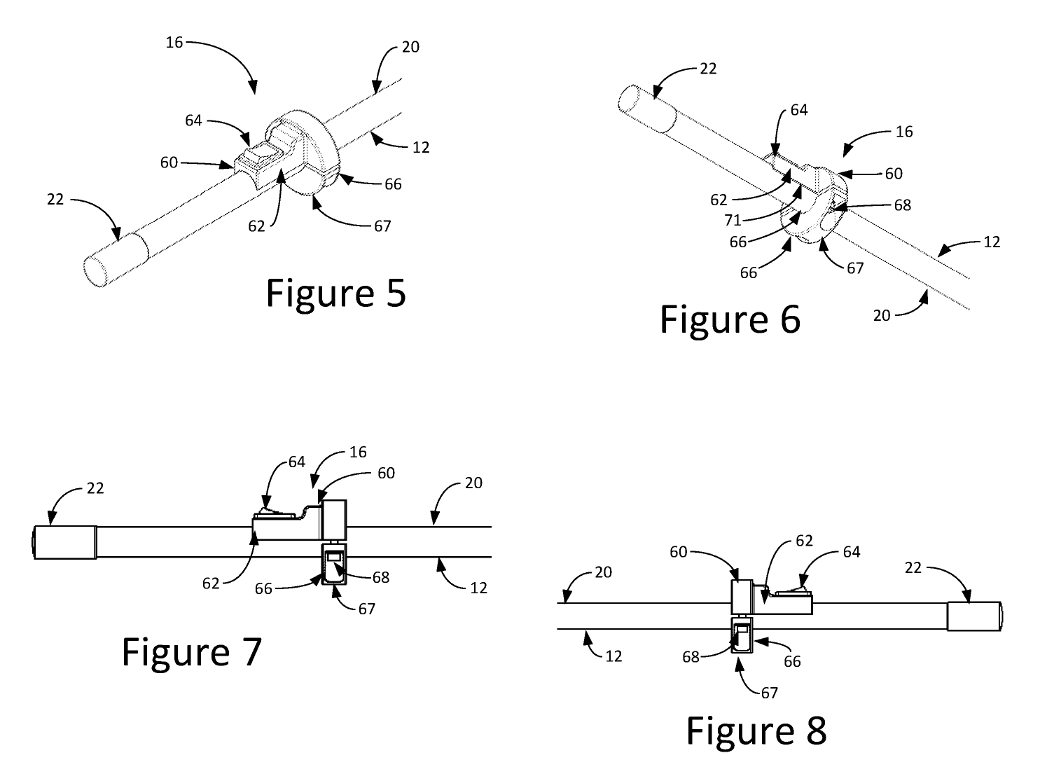

The tool control transmitter 16 is shown in FIGS. 5 through 8 as comprising body 60, control circuitry 62, actuator 64 and mounting assembly 66. The tool control transmitter 16, as will be explained, is positioned proximate the first end 26 of the elongated body of the insulated pole, spaced apart from the tool 14, and electrically isolated therefrom. The body 60 typically comprises a housing defining a cavity. Typically, the body 60 comprises an injection molded polymer component, although others are contemplated. The control circuitry 62 includes a means by which to communicate with the tool control receiver 48 of the tool 14. To maintain the electrical isolation, the communication can be achieved through any number of different wireless means, including, but not limited to RF, IR, WiFi, BLUETOOTH®, ZIGBEE®, personal network bands such as those of IEEE Standard 802.15.4, among others. It will be understood that the distance between the tool control receiver 48 and the tool 14 is relatively short, and, as such, any number of the protocols (many of which can be implemented quite easily and in a cost effective manner) can be utilized.

The actuator 64 may comprise a plurality of switches, toggles, buttons and the like which are configured to direct the tool control transmitter to transmit a signal to the tool control receiver so that the tool undertakes a certain action. For example, in the case of an impact driver, a first button can be provided which directs the tool control transmitter to send a signal to the tool control receiver to rotate in a first direction. A second button can be provided which imparts a similar action in the opposite direction. Other embodiments may include different buttons, toggles, switches, triggers, and the like to achieve the necessary control over the tool 14. For example, with a chainsaw, a trigger may be employed which can send signals to the tool corresponding to variability of the force applied to the device.

The mounting assembly 66 comprises a clamp member 67 and a plurality of fasteners 68. It will be understood that the body 60 includes a lower, insulated pole mounting surface 71. Thus, preferably the insulated pole mounting surface 71 shape matingly corresponds to the arcuate configuration of the insulated pole, so as to provide a mating configuration for purposes of coupling thereto. Similarly, the clamp member 67 includes a surface 72 which shape matingly engages with the elongated body of the insulated pole opposite of the portion to which the pole mounting surface 71 is mounted upon. Thus, when combined, the insulated pole mounting surface 71, the two components extend around the insulated pole and sandwich the insulated pole therebetween. The fasteners 68 are configured to couple the elongated body and the clamp 67 to each other, to maintain the releasable engagement. In other embodiments, the clamp may comprise a quick release mechanism, or other mechanism that can releasably retain the tool control transmitter 16 to the body of the insulated pole.

The tool control transmitter 16 is positioned along the insulated pole 12 at a strategic position therealong. For example, for a 230 kV line, there must be at least 5′3″ of distance of the insulated pole between the second end and the first end thereof. In such an instance, the control transmitter 16 can be positioned outside of this limit, and, thus, can form a stop for the user's hands, thereby limiting the user from extending his or her hand beyond the control transmitter (and thus, keep the user beyond the 5′3″ minimum).

It will be understood that the tool control transmitter may be integrally coupled to the insulated pole, wherein the insulated pole and the transmitter are provided as an integrated unit. In other embodiments, the tool control transmitter may be permanently coupled thereto. In many embodiments, a quick release or other releasable retention is contemplated. This is advantageous because it allows for a first user to use both arms to retain the insulated pole, while an associate utilizes the tool control transmitter to provide instructions to the tool and to control the same.

In operation, the user first selects the tool 14 that will be utilized. For example, an electric impact wrench can be selected. The user then assembles the tool so that it is complete. First, the user insures that an adequate power source 42 is provided and coupled to the tool body. Generally, the power source 42 comprises a battery pack, such as an 18V Lithium Ion battery pack. Once coupled, the user can then select an impact socket for use and attachment to the tool working end by coupling the impact socket to the socket drive thereat.

At the same time, the insulated pole is selected. Among other determinations, the particular use and the location where the use will take place are among a number of different considerations when selecting the insulated pole. Once both the tool and the insulated pole are selected, the two must be coupled together. To achieve the same, the flange 30 of the tool attachment assembly 24 of the insulated pole 12 and the flange 50 of the attachment member 46 of the tool 14 are coupled together. In particular, the two are positioned in an overlying configuration so that the openings 32, 52 line up with each other. Finally, fastener 34 is extended therethrough and tightened. As the fasteners are tightened, the tool can be pivoted relative to the insulated pole so that the two are angularly disposed relative to each other in the desired configuration. Fully tightened, the two are locked to each other and are precluded from relative movement.

The tool control transmitter 16 is also coupled to the insulated pole. It will be understood that the tool control transmitter can be coupled at any point after the selection of the tool and the insulated pole. In the embodiment shown, the tool body 60 is positioned along the insulated pole in the proper position. In such a position, the pole mounting surface abuts the insulated pole. Once positioned, the clamp 67 is then positioned in the desired orientation. Finally, when the two are positioned in a final orientation, the fasteners 68 clamp the two structures together. The fasteners are tightened and the tool control transmitter 16 is in the proper desired operational configuration.

To utilize the tool, the user, often referred to as a lineman, is first positioned in the proper location. In the embodiment shown, the lineman could utilize the assembly to tighten a bolt or the like. Often times, the lineman is positioned through the use of a bucket truck (often referred to as a cherry picker), on an aerial work platform or other structure. It will be understood that when working on high-voltage electrical power lines, until it is known with certainty as being otherwise, the lineman must assume that the line is live and, that the line is energized.

Once positioned in the proper location, the lineman can position the tool in a working orientation (i.e., the impact socket can be coupled to a bolt or the like). Once coupled, the lineman can utilize the tool control transmitter to control the tool. In the embodiment shown, the tool control transmitter has an actuator which comprises a plurality of switches. The switches provide different control instructions to the tool, such as rotation direction, rotation speed, etc. Thus, the lineman can control the tool that is remotely positioned.

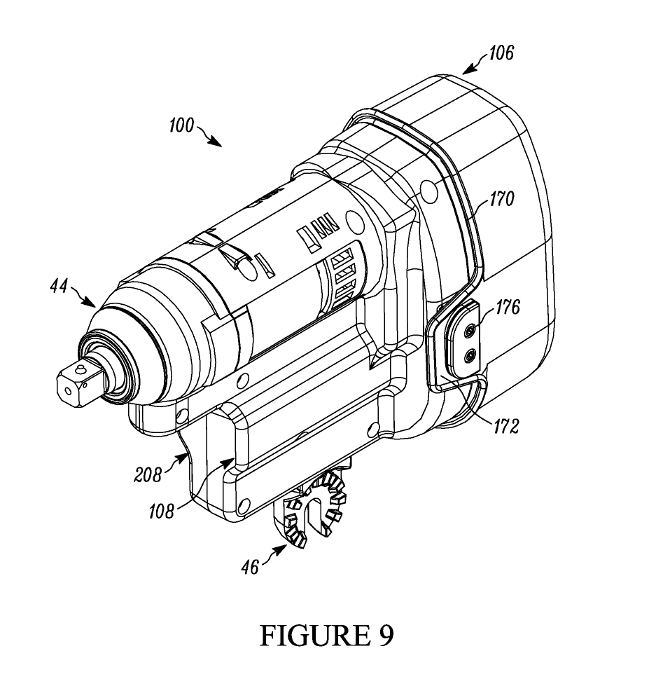

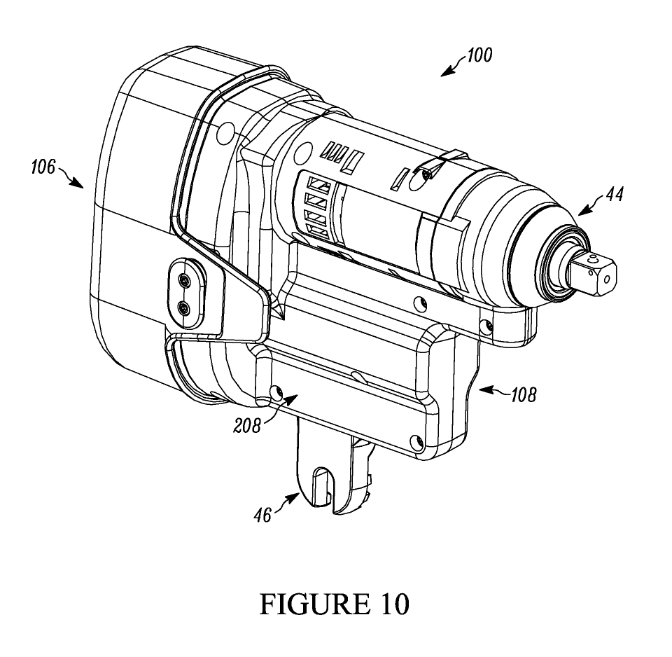

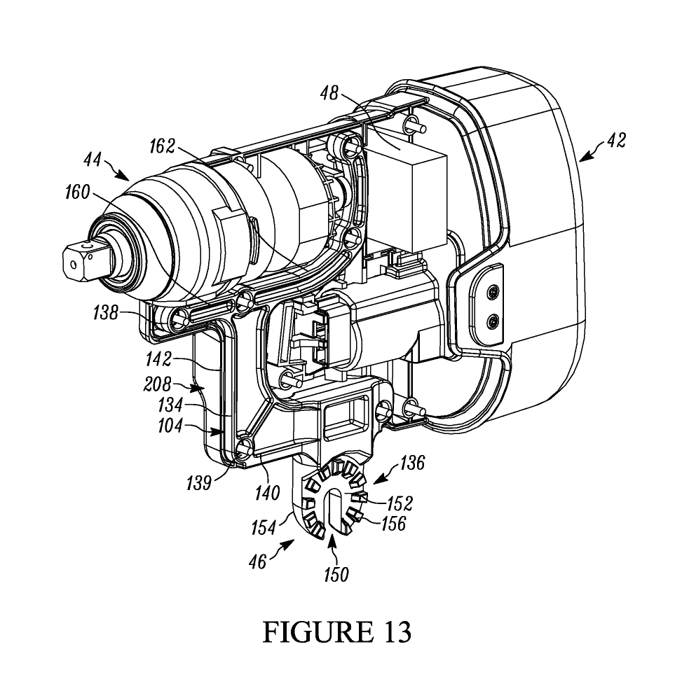

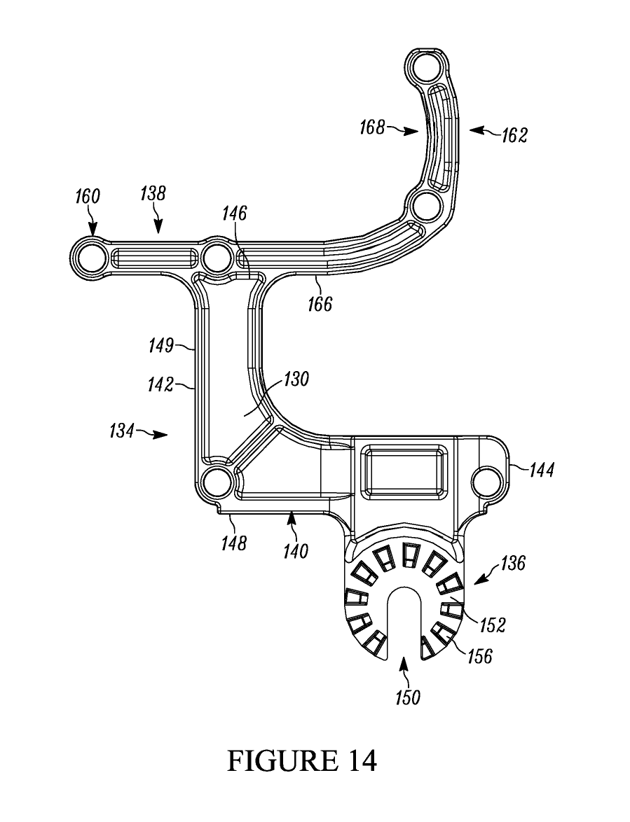

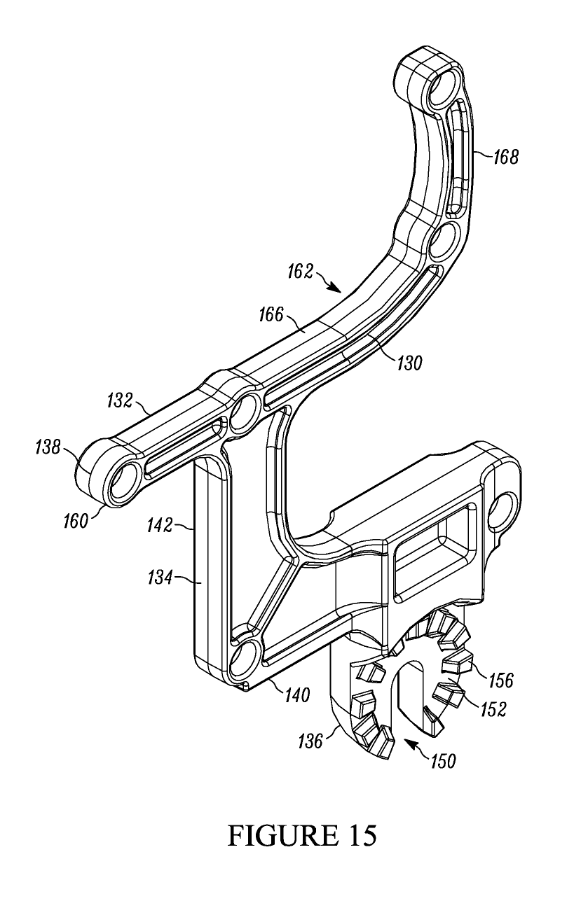

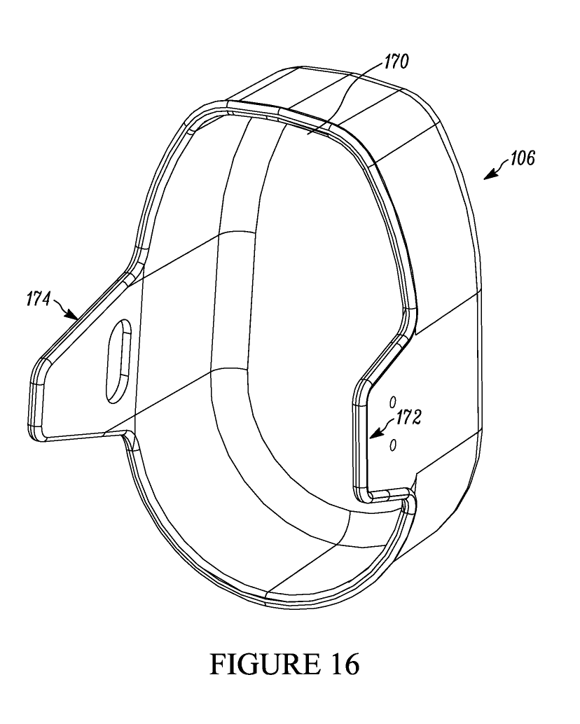

With reference, now, to FIGS. 9 through 16, a particular configuration of the body 40 is disclosed and shown as tool body assembly 100. The tool body assembly 100 includes case assembly 102, frame spine member 104 and battery cover 106. As will be understood, the tool body assembly 100 retains the power source 42, tool work end 44, control circuitry 48 and forms the attachment member 46.

The case assembly 102 is shown in FIGS. 9 and 10 as comprising first case half 108 and second case half 208. It will be understood that the first and second case halves are substantially mirror images of each other (with some variation in the internal structures or external configuration) and have relatively similar, mirror image-like functions. As such, the first case half will be described with the understanding that the first and second case halves have substantially the same structural and functional features. The features disclosed above will be identified on the second case half with the same reference numerals, augmented by an additional 100 (i.e., so that the second case half is identified by a number that is 100 more than the first case half 108, or by the number 208)

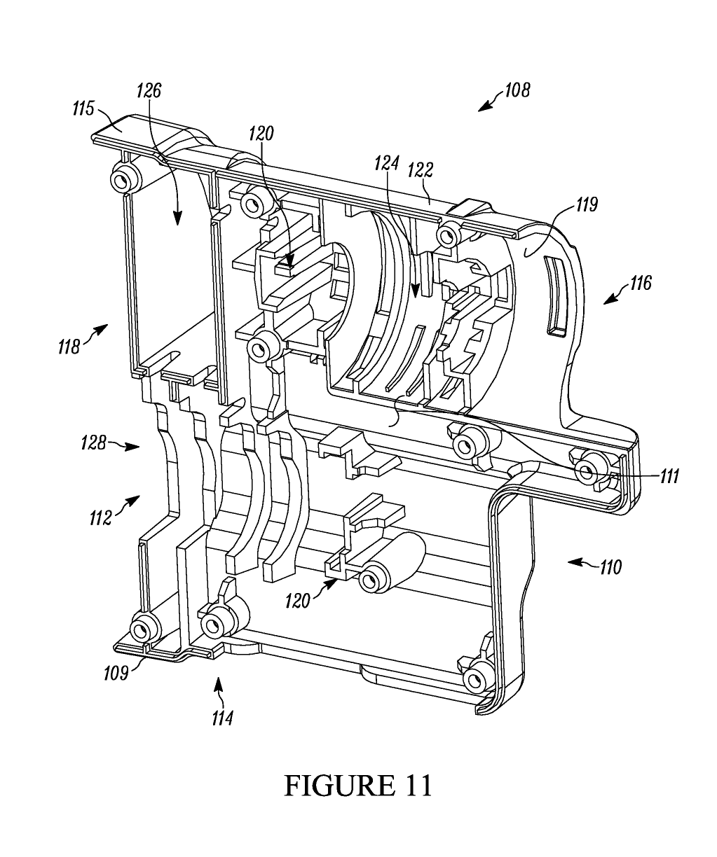

As shown in FIG. 11, the first case half 108 includes front end 110 and back end 112, as well as outer surface 119 and inner surface 122. The inner surface is defined by a plurality of inner rib or wall structures 120. These structures define a plurality of cavities. These cavities include tool work end cavity 124 (which houses the gear-motor components), controller cavity 126 and battery cavity 128. A lower opening 114 is centrally located about the lower end of the first case half to accommodate the attachment member. An upper opening 116 provides egress for the tool work end from tool work end cavity 124. A batter pack opening 118 is positioned at the back end 112 of the structure, and provides an opening for accommodating the power source. The opening extends from the battery cavity 128 and defines outer rim 115.

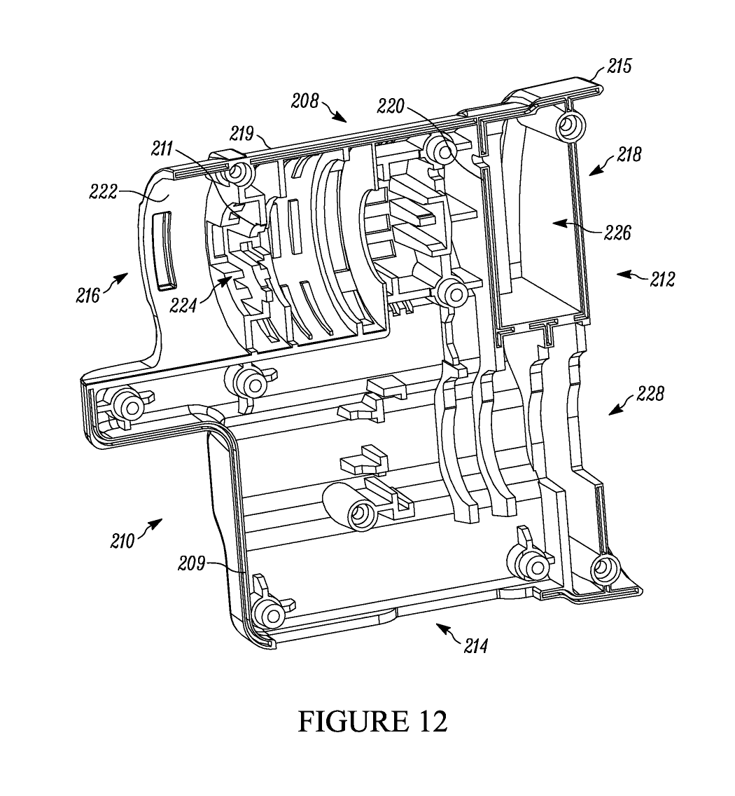

As explained above, and with reference to FIG. 12 the second case half 208 includes front end 210 and back end 212, as well as outer surface 219 and inner surface 222. The inner surface is defined by a plurality of inner rib or wall structures 220. These structures likewise define the tool work end cavity 224, controller cavity 226 and battery cavity 228. The lower opening 214 is centrally located. The upper opening 216 provides egress for the tool work end from the tool work end cavity 224. The battery pack opening 218 is positioned at the back end 212 of the structure and provides the opening for the power source. The opening defines the outer rim 215.

It will be understood that the two case halves are joined together about their respective joining perimeter rims 109, 209. This coupling joins the two structures together and defines the cavities that are partially formed by each one of the case halves. In the configuration shown, the case halves form the larger power source opening and the relatively smaller tool work end opening. Additionally, the two form the lower opening for the attachment member.

In the configuration shown, the two case halves sandwich the frame spine member. The frame spine member provides a structure that supports the different component sand cavities presented by the case halves, as well as provides the necessary structure for coupling to the outside insulated pole.

In the configuration shown, the frame spine member 104 comprises first side 130 and second side 132. The first side faces the first case half 108 and the second side faces the second case half 208. The lower portion of the tool and the front portion of the tool generally follow the configuration of the frame spline member. Generally, the frame spine member comprises a metal member (whereas the case halves may comprise a polymer based member), such as aluminum and magnesium alloys, steel, or other metal materials.

The frame spine member includes a number of different portions, including a generally L-shaped primary body 134, lower projection 136 and upper transverse beam 138. The L-shaped primary body 134 includes substantially horizontal leg 140 and substantially vertical leg 142 which are disposed at generally right angles relative to each other. The vertical leg 142 extends along the front end 110, 210 of the case halves. The vertical leg includes upper end 146 as well as outer surface 149 which matches the front end of the case halves. The horizontal leg 140 includes inner end 144 as well as lower surface 148.

A lower projection 136 extends from the lower surface 148 of the horizontal leg 140 in a downward direction away from the case assembly 102, and generally perpendicular to the horizontal leg 140. The lower projection defines the attachment member 46 and is structurally configured for coupling to the insulating pole 12 at the distal end thereof. The lower projection 136 includes slot 150 which has opposing surfaces 152, 154, one or both of the structures include nibs or projections which can lock with similar structures on the distal end of the insulating pole to rotationally lock the structures together.

The upper transverse beam 138 extends in a direction that is generally perpendicular to the vertical leg 142 and is generally positioned at the upper end 146 thereof. The upper transverse beam 138 includes front portion 160 and back portion 162. The front portion extends toward the front end of the case halves and the back portion extends away from the front end and toward the back end of the case halves. The front portion is substantially planar and substantially perpendicular to the vertical leg 142. The back portion includes two portions. The first portion is the flat portion 166 which is generally collinear with the front portion 160. The second portion 168 comprises a upwardly configured portion which generally curls around the back of the tool work end. The curled portion generally corresponds spatially to the lower projection 136, while curling in the opposite direction therefrom.

A plurality of openings are disposed on the frame spine member 104 along the structure thereof. The openings are configured to correspond to similar openings on each of the first and second case halves. Suitable fasteners can be directed therethrough to sandwich the frame spine member between the first case half and the second case half. It will be understood that in some portions of the case halves, the fasteners may couple the first and second case half to each other without sandwiching the frame spine member therebetween.

The battery cover 106 extends over the battery pack opening 118 so as to cover the battery pack (or power source) that is positioned therein. The battery cover 106 includes outer rim 170 which generally shape-matingly matches the outer rim 115, 215 formed by the first and second case halves when assembled. The battery cover further includes a first side extension 172 and a second side extension 174. The first side extension 172 extends over the outside of the first case half 108 and the second side extension 174 extends over the outside of the second case half 208. Fasteners are provided that can extend through the first and second side extensions and into the corresponding case half to join the same. In other configurations, the battery cover may be otherwise coupled to the case halves, such as through a snap fit or the like. In still other configurations, the battery cover may be integrally formed with the case halves, wherein the battery cavity does not include a battery pack opening that is accessible when the case halves are assembled. Still other configurations may omit the battery cover, and may rely on the battery pack housing alone.

As such a system is configured for use in association with live line conditions wherein experienced voltages may be in excess of 230 kV, 345 kV even to 500 kV, radio interference becomes problematic. To solve the interference issues caused by voltages in excess of, typically, 150 kV, a Faraday cage was formed about the portions of the device that require shielding (i.e., at least the battery and the controller/control circuitry). Inventively, the Faraday cage is formed by applying a conductive paint 111 to the inner surface of each of the first case half and the second case half. Of course, the application could be to the outside, however, application to the inside tends to be more durable. Additionally, as the battery pack is accessible by the user in the configuration shown, a conductive rubber boot forms the battery cover, or a portion of the battery cover. As may be understood, without such isolation, when approaching a live line conductor of such voltage, the levels of noise experienced may preclude reliable operation (due to the charging arc between the conductor and the device). Once the components touch, generally the noise reduces, and more reliable operation is experienced. With the Faraday cage as described and shown, reliable operation can be achieved during the entire operation.

To assemble the device, the user places the tool work end into the tool work end cavity 124 (wherein, each of the structures may include structures to receive and retain the tool work end in the proper configuration and orientation). Next, the control circuitry 48 is positioned with the controller cavity, and coupled therein. Next, the battery pack can be slid into the battery cavity 128 and locked in position. It will be understood that the battery pack, the tool work end and the control circuitry are coupled together in electrical communication with suitable wiring (which has been omitted from the figures for pictorial clarity), and which will be understood to one of ordinary skill in such arts. It will further be understood that the battery pack may be easily removable and replaceable as a unit (i.e., having its own housing)

Additionally, the frame spine member is positioned in the proper orientation along the first case half. Once these components have been positioned, the second case half can be introduced into the proper position, sandwiching the frame spine member therebetween. Once complete, fasteners can be directed through each of the case halves and the frame spine member to secure the three components together in engagement. The battery cover can then be introduced and mated to the case halves. In particular, the battery cover is placed over the battery and matingly engages with the outer rim of the battery pack opening. The first side extension and the second side extension overlie the first and second case halves, respectively. Once positioned, fasteners can be directed through the side extensions into the respective one of the first and second case half.

In operation, the user can couple the attachment member to the distal end of the insulating pole. Due to the distribution of the components and the configuration of the frame, the frame provides support to the components that are positioned in a manner that essentially eliminates a rotational moment about the attachment member, as the weight distribution is essentially centered about the attachment member. In addition, the frame spine member 104 provides the necessary support for the tool work end and the power source to maintain the control of the device by the user solely through contact through the attachment member. Furthermore, the tool work end is positioned on the opposite side of the attachment member from the tool working end. Further still, the attachment member extends or depends from the lower end of the case assembly centrally located, thereby allowing for varying positions and orientations of the insulating pole relative to the attachment member.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A tool body assembly for a remote control tool assembly for use in live line environments comprising:
a case assembly having a first case half and a second case half that matingly engage about respective outer rims, each of the first case half and second case half including,
a tool work end cavity;
a controller cavity;
a battery cavity; and
an upper opening in communication with the work end cavity; and
a frame spine member positioned between the first case half and the second case half so as to be sandwiched therebetween, the frame spine member including,
a primary body including a substantially horizontal leg and a substantially vertical leg, with a lower projection extending from the substantially horizontal leg and beyond the case assembly to define an attachment member structurally configured to receive a distal end of an insulating pole, and an upper transverse beam extending between the tool work end cavity and the battery cavity.

2. The tool body assembly of claim 1 wherein the first case half and the second case half are substantial mirror images of each other.

3. The tool body assembly of claim 1 wherein the lower projection defines the lowermost portion of the tool body assembly.

4. The tool body assembly of claim 3 wherein the center of mass is positioned at the lower projection, so that half of the mass is to one side of the lower projection and half of the mass is to the other side of the lower projection.

5. The tool body assembly of claim 1 further including a Faraday cage positioned about at least the battery cavity and the controller cavity.

6. The tool body assembly of claim 5 wherein the Faraday cage comprises a conductive paint applied to the inner surface of the first case half and the second case half.

7. The tool body assembly of claim 6 wherein the Faraday cage further comprises a conductive rubber boot extending about the battery cavity.

8. The tool body assembly of claim 1 wherein the upper transverse beam extends from the substantially vertical leg of the primary body and includes a front end and back portion, with the back portion including a flat portion that is substantially collinear with the front portion, and an upwardly curved portion beyond the flat portion.

9. The tool body assembly of claim 8 wherein the upwardly curved portion substantially corresponds to the lower projection, while being spaced apart therefrom by the substantially vertical leg.

10. The tool body assembly of claim 1 wherein the frame spine member and the first and second case halves each include corresponding openings structurally configured to allow for a fastener therethrough, to, in turn, couple the structures together, sandwiching the frame spine member therebetween.

11. The tool body assembly of claim 1 wherein the battery pack cavity further includes a battery pack opening that provides ingress into the battery cavity.

12. The tool body assembly of claim 11 further including a battery cover structurally configured to extend about the battery pack opening, the battery cover being coupled to the first case half and the second case half.

13. The tool body assembly of claim 11 wherein the battery cover includes a conductive rubber material to form a Faraday cage therearound.

14. A tool comprising:
a tool body assembly for a remote control tool assembly for use in live line environments comprising:
a case assembly having a first case half and a second case half that matingly engage about respective outer rims, each of the first case half and second case half including,
a tool work end cavity;
a controller cavity;
a battery cavity; and
an upper opening in communication with the work end cavity; and
a frame spine member positioned between the first case half and the second case half so as to be sandwiched therebetween, the frame spine member including,
a primary body including a substantially horizontal leg and a substantially vertical leg, with a lower projection extending from the substantially horizontal leg and beyond the case assembly to define an attachment member structurally configured to receive a distal end of an insulating pole, and an upper transverse beam extending between the tool work end cavity and the battery cavity;
a power source positioned within the battery cavity;
a tool working end positioned within the battery cavity with a tool coupling member extending through the upper opening; and
control circuitry positioned within the controller cavity, and electrically coupled to each of the poser source and the tool working end.

15. The tool of claim 14 wherein a Faraday cage is formed around the power source and the control circuitry.

16. The tool of claim 15 wherein the Faraday cage comprises a conductive paint coating the first and second case half and a conductive rubber boot about the battery.

17. The tool of claim 15 wherein the lower projection extends from the tool body assembly in a position such that half of the weight of the tool is on one side of the lower projection with half of the weight of the tool on a side opposite the one side of the lower projection so that the tool is balanced about the lower projection.
